(19) United States
(12) Patent Application Publication
(10) Pub. No.: US 2015/0176398 A1
(43) Pub. Date: Jun. 25, 2015

(54) METHOD FOR DETERMINING CHANGE OF PROPERTIES IN A NEAR-BOREHOLE ZONE OF A FORMATION DUE TO INVASION OF A DRILLING MUD

(71) Applicant: SCHLUMBERGER TECHNOLOGY CORPORATION, Sugar Land, TX (US)

(72) Inventors: Dmitry Nikolaevich Mikhailov, Moscow (RU); Nikita Ilyich Ryzhikov, Moscow (RU); Alexander Alexandrovich Burukhin, Moscow (RU); Anna Viktorovna Zharnikova, Moscow (RU)

(21) Appl. No.: 14/581,458

(22) Filed: Dec. 23, 2014

(30) Foreign Application Priority Data
Dec. 25, 2013 (RU) 2013157418

(51) Int. Cl. E21B 47/14; G01N 15/08

(52) U.S. Cl. CPC E21B 47/14; G01N 15/088; G01N 15/082

(57) ABSTRACT

A core sample is taken from a wall of a borehole and at least one core fragment is cut from the core sample. The irradiation of the core fragments is carried out with longitudinal acoustic waves and a propagation velocity of the longitudinal acoustic waves in each of the core fragments is measured. An empirical relationship between a velocity of a longitudinal acoustic wave and a porosity for a given lithological type of the rock is selected. A porosity for each core fragment is determined using the measured velocities of the longitudinal acoustic wave and the selected empirical relationship. A value for porosity change is determined by comparing the determined porosity values for the core fragments and a value of a reference porosity typical for the given lithological type of the rock.

### CROSS-REFERENCE TO RELATED APPLICATION

This application claims priority to Russian Application No. 2013157418 filed Dec. 25, 2013, which is incorporated herein by reference in its entirety.

### BACKGROUND

The invention relates to methods for non-destructive analyzing core samples; in particular, it can be used for quantitative studying deterioration of properties in a near-borehole zone of oil/gas-containing formations due to penetration of drilling mud components therein.

In the process of drilling influenced by an excessive pressure, a filtrate of a drilling mud as well as fine particles contained therein, polymers and other components penetrate into a near-borehole zone of a formation and cause significant reduction in the porosity and permeability thereof. In addition, an external filter cake comprised of filtered solid particles and other components of the drilling mud is formed on a wall of a borehole.

During the technological procedure of cleaning the borehole (by gradual putting into production), the external filter cake is partially broken while the penetrated components of the drilling mud are partially washed out of the near-borehole zone, and its porosity and permeability are partially restored. Nevertheless, a portion of components remains irreversibly held in a pore space of a rock (adsorption on surfaces of pores, capture in steam restrictions, etc.) which results in an essential difference between an initial permeability and a permeability restored after carrying out the technological cleaning procedure (usually, the restored permeability is not greater than 50 to 70% of the initial permeability).

To describe this phenomenon, the term “a damage of a near-borehole zone of a formation” or simply “a formation damage” is usually used.

The problem of damaging the near-borehole zone of the formation due to penetrated components of the drilling mud (or a flushing fluid) is very important, especially for long horizontal boreholes, because the most of them are completed in the uncased state, i.e., without a cemented and perforated production string.

The conventional laboratory technique for checking a quality of a drilling mud is a filtration experiment comprising injection of the drilling mud into a core sample followed by back injection (i.e., displacement of the penetrated drilling mud with an initial formation fluid) in progress of which a permeability deterioration/restoration dynamics as a function of an amount of pore volumes filled with pumped fluids (the drilling mud or the formation fluid) is measured.

Said conventional technique allows measurement only of an integral hydraulic resistance of a core sample (a ratio of a current pressure differential across the core to a current flow rate), the change of which is caused by the growth/destruction dynamic of an external filter cake at an end face of the core and by accumulation/removal of the drilling mud components in the rock.

However, a damaged porosity and permeability profile along the core sample (along a filtration axis) after pumping of the drilling mud in (or after back pumping) is important information to understand the formation damage mechanism and to select a respective technique for increasing a wellbore productivity index (to minimize a damage of a bottomhole formation zone). The present parameters are not measured within said traditional procedure of the drilling mud quality check.

To determine said parameters, it is necessary to attract additional techniques.

U.S. Pat. No. 5,253,719 discloses a method for diagnosing formation damage mechanisms by analyzing radially oriented core samples taken from a borehole. The core samples are analyzed through a number of different analytical methods to determine the type and the extent of the formation damage as well as the depth that the damage zone extends out. An x-ray diffraction (XRD) analysis, a local x-ray spectral analysis, a scanning electron microscope (SEM) examination, back-scattered electron microscopy, petrographic analysis, and optical microscopy are listed among the analytic methods. Experimental determination of the core porosity and permeability is further possible.

All methods listed in U.S. Pat. No. 5,253,719 are rather time and labor consumable methods of investigation, and the most of them require destruction of the initial core samples.

As an alternative, acoustic method of investigation can be used, for example.

US 2009/0168596 of Jul. 2, 2009, discloses a method for estimating formation porosity and lithology on a real time basis during a logging while drilling operation using measured values of formation attenuation attributes for compression and/or shear waves. Measured attributes are used with an empirical lithology map to determine lithology, porosity and saturation of a production level when these are unknown.

US 20011/0242938 of Oct. 6, 2001, discloses methods and embodiments of analyzing core samples taken from a borehole. The disclosed methods may include extracting a first core sample from a wellbore with a coring tool at a first depth, ultrasonically measuring a sound speed of the first core sample, transmitting the ultrasonically measured sound speed of the first core sample to a display unit, analyzing the ultrasonically measured sound wave speed in real time, extracting a second core sample at the first depth if the first core sample is determined to be low quality, and extracting the second core at a second depth if the first core is determined to be high quality. US 20011/0242938 further declares determination of one of the parameters as follows: homogeneity, integrity, and lithology of core samples based on the obtained ultrasonic wave profile.

US 2009/0168596 and US 20011/0242938 noted above are directed to determination of such core sample properties as porosity, saturation behavior, lithology based on attributes of the waves propagated through the sample under study. Said patents do not stipulate for determination of a change in properties of a rock in the near-borehole of the formation, said change resulting from subjection to components of the drilling mud or other process fluids (for the sake of statement simplicity, let us name penetrated components as “contaminant”).

### SUMMARY

The disclosure provides for determining changes of rock properties in a near-borehole zone of a formation, said changes resulting from action of a contaminant.

The proposed method comprises taking a core sample from a wall of a borehole and cutting at least one core fragment of the core sample. The core fragments are irradiated with longitudinal acoustic waves and a velocity of the longitudinal acoustic waves in each core fragment of the core sample is measured.

An empirical relationship between a velocity of the acoustic wave and a porosity for a given lithological type of the rock is selected, and a porosity of each core fragment is determined using the selected empirical relationship and the measured velocities of the longitudinal acoustic waves. A value of a porosity change is determined by comparing the determined porosity values of the core fragments and a value of a reference porosity typical for the given lithological type of the rock.

In accordance with one of embodiments of the disclosure, the reference porosity is an undamaged porosity for a similar lithological type of the rock.

In accordance with another embodiment of the disclosure, the reference porosity is a porosity known from available geological and geophysical information for a given reservoir formation.

In accordance with another embodiment of the disclosure, the reference porosity is a porosity calculated from a propagation velocity of acoustic longitudinal waves measured in a core fragment, from the core sample, remote from the wall of the borehole.

In accordance with another embodiment of the disclosure, the reference porosity is a porosity measured in a core fragment of the core sample.

An analytic dependence or a dependence in the form of a nomographic chart or a dependence according to the Frenkel-Biot-Nikolaevsky theory is used as the empirical relationship between the velocity of the acoustic wave and the porosity.

In accordance with one of embodiments of the disclosure, the obtained values of the changed porosity are used to correct an interpretation of acoustic logging data.

In accordance with another embodiment of the disclosure, a value of a permeability change is determined along with determination of a value of the porosity change, for which purpose a longitudinal wave attenuation factor or amplitude during irradiating with the longitudinal acoustic waves is measured. An empirical relationship between a wave attenuation factor and a porosity for a given lithological type of the rock is selected, and a value of the permeability change is determined by comparing the determined permeability values and a value of a reference permeability typical for the given lithological type using the measured longitudinal wave attenuation factors or amplitudes and the selected empirical relationship between the wave attenuation factor and the porosity for the given lithological type of the rock.

The reference permeability is a known undamaged permeability for a similar lithological type, or a permeability known from available geological and geophysical information for the given reservoir formation, or a permeability calculated from an attenuation factor of the acoustic longitudinal waves measured in a core fragment, from the core sample, that is remote from the wall of the borehole, or a permeability measured for the core fragment of the core sample.

An analytic dependence or a dependence in the form of a nomographic chart or a dependence according to the Frenkel-Biot-Nikolaevsky theory is used as the empirical relationship between the velocity of the acoustic wave and the permeability.

In accordance with another embodiment of the disclosure, when cutting two or more core fragments of the core sample, a porosity change depth along with measurement of the porosity change value is measured for which purpose the core fragments corresponding to different distances from the wall of the borehole are cut. In this case, a permeability change depth can be further measured, for which purpose a longitudinal wave attenuation factor or amplitude is measured when irradiating each of the core fragments with the longitudinal acoustic waves. An empirical relationship between the wave attenuation factor and permeability for the given lythological type of the rock is selected, and a value of the permeability change is determined by comparing the determined permeability values and a value of a reference permeability typical for the given lithological type using the measured longitudinal wave attenuation factors or amplitudes and the selected empirical relationship between the wave attenuation factor and the porosity for the given lithological type.

Either a known undamaged permeability for a similar lithological type or a permeability known from the available geological and geophysical information for the given reservoir formation or a permeability calculated from the attenuation factor of the acoustic longitudinal waves measured in a core fragment, from the core sample, that is from the wall of the borehole or a permeability measured for the core fragment is taken as the reference permeability.

An analytic dependence or a dependence in the form of a nomographic chart or a dependence according to the Frenkel-Biot-Nikolaevsky theory is used as the empirical relationship between the velocity of the acoustic wave and the permeability.

### BRIEF DESCRIPTION OF DRAWINGS

The invention is explained by the drawing where

FIG. 1 is a qualitative diagram of a near-borehole zone and a region for side sampling a core from borehole walls.

### DETAILED DESCRIPTION

It is common knowledge that a velocity and an attenuation factor of acoustic (elastic) waves in a porous medium depends upon such properties of the porous medium as porosity, permeability, compressibility and density of phases which constitute said medium, etc.

The theory of wave propagation in porous media developed by Frenkel, Biot and Nikolaevsky (cf., Biot, M. A. Theory of propagation of elastic waves in a fluid-saturated solid. I. Low frequency range//J. Acoust. Soc. Amer. 1956. V. 28. pp. 168-178. II. Higher frequency range//J. Acoust. Soc. Amer. 1956. V. 28. pp. 179-191, or Nikolaevsky, V. N. Geomechanics and Fluidodynamics with applications to reservoir engineering. SpringerVerlag, Dordrecht, 1996, pp. 50-57, 65-72) forecasts the existence of two types of longitudinal waves: a “fast” wave (or a longitudinal first-type wave) and a “slow” wave (or a longitudinal second-type wave). The second-type wave within a frequency range of from 0.5 to 10 MHz, which corresponds to typical laboratory measurements, is defined by intensive attenuation, especially in saturated rocks, and therefore cannot propagate for any significant distances.

Thus, the present disclosure is directed to consideration of attributes of the longitudinal first-type wave.

Another consequence of the Frenkel-Biot-Nikolaevsky theory is the longitudinal first-type wave speed versus rock density dependence as well as saturating fluid compressibility and density and rock matrix. The first-type wave attenuation factor and dispersion depend upon rock permeability as well (i.e., there is the phase velocity-frequency dependence).

Simple empirical correlations are typically used in interpretation of acoustic logging data. For example, the time-average equation (or Willie equation) which correlates a wave interval transit time and a rock porosity (cf., Log interpretation principles/applications by Schlumberger. 1989, Chapter 5, p. 6) is widely used to estimate the porosity in a dense, well-cemented rock:

$${t}_{LOG} = φ {t}_{f} + ( 1 - φ ) {t}_{ma} , or \\ φ = \frac{{t}_{LOG} - {t}_{ma}}{{t}_{f} - {t}_{ma}} , \qquad ( 1 )$$

where φ is the rock porosity; t_{LOG} is the interval transit time for transiting the wave though the rock, as recorded in acoustic logging; tₘₐ is the wave interval transit time in a mineral rock matrix; t_{f} is the wave interval transit time in a saturating fluid.

The equation (1) corresponds to the fact that a longitudinal wave interval transit time (i.e., a time of wave propagation along the path of the unit length, and therefore, said time is reversely proportional to a value of a wave velocity) in the dense, well-cemented rock is a volume-averaged value of the wave interval transit time in the mineral rock matrix and in the fluid filling the pore space.

An empirical correction factor Cₚ is introduced to estimate the porosity of poorly cemented rocks on the basis of acoustic logging data (cf., Log interpretation principles/applications by Schlumberger. 1989, Chapter 5, p. 7):

$${φ}_{cor} = \frac{{t}_{LOG} - {t}_{ma}}{{t}_{f} - {t}_{ma}} \frac{1}{{C}_{p}} \qquad ( 2 )$$

Other empirical correlations (analytical or in the form of a nomographic chart) also exist between the wave transit time and the porosity, said correlations having been obtained for different rock types (cf., Vendel'shtein, B. Ju., Rezvanov, R. A. “Geofizicheskie metody opredeleniya parametrov nefnegazovykh kollectorov pri podschete zapasov i proektirovanii razrabotki mestorozhdeny” (Geophysical techniques for determining oil and gas reservoirs in calculation of reserves and design of development of deposits). Moscow, “Nedra” (Depths Publishers), 1978, pp. 132-143; “Inerpretatsia rezul'tatov geofizicheskikh issledovany neftyanykh i gasovykh skvazhin. Spravochnik” (Interpretation of results in geophysical studies of oil and gas boreholes. Reference book). Moscow: “Nedra”, p. 176).

Penetration of drilling mud components leads to reduction in the porosity from an initial value φ₀:

φ_{d}=φ₀−σ, (3)

where σ is a proportion by volume of captured particles per volume unit of a porous medium.

The porosity reduction, in turn, gives rise to the longitudinal wave velocity (results in decrease of the interval transit time).

A degree of the porosity damage (change) can be quantitatively estimated on the basis of the measured values of the longitudinal wave propagation velocity (interval transit time) in a core sample subjected to the drilling mud and in a core sample of the similar lithological type (lithotype) with the original, undamaged porosity, said estimation being carried out using a known empirical (analytical or in the form of a nomographic chart) interrelation between the wave transit time and the porosity for a given rock type, cf., Wyllie M. R. J., Gregory A. R., Gardner G. H. F. An experimental investigation of factors affecting elastic wave velocities in porous media. 1958, Vol. 23, No. 3, pp. 459-493, or being carried out on the basis of the Frenkel-Biot-Nikolaevsky theory, cf., Biot M. A. Theory of propagation of elastic waves in a fluid-saturated solid. I. Low frequency range//J. Acoust. Soc. Amer., 1956, V. 28, pp. 168 to 178. II. Higher frequency range//J. Acoust. Soc. Amer. 1956, V. 28, pp. 179-191, or Nikolaevsky V. N. Geomechanics and Fluidodynamics with applications to reservoir engineering. SpringerVerlag, Dordrecht, 1996, pp. 50-57, 65-72).

For example, a degree of the porosity change for the correlation (1) is determined as:

$$\frac{{φ}_{0}}{{φ}_{d}} = \frac{{t}_{LOG}^{0} - {t}_{ma}}{{t}_{LOG}^{d} - {t}_{ma}} , \qquad ( 4 )$$

where t^{d}_{LOG} [symbol] t⁰_{LOG} are interval times of transiting the wave through the core sample subjected to the drilling mud and the core sample of the similar lithotype with the initial, undamaged porosity.

The obtained data of a depth and a degree of the porosity reduction can be used to correct the interpretation of acoustic logging data.

Using the Frenkel-Biot-Nikolaevsky theory, a change of the rock permeability can be estimated on the basis of the measured values of the longitudinal wave attenuation factor in the core sample subjected to the drilling mud and the core sample of the similar lithotype with the initial, undamaged porosity.

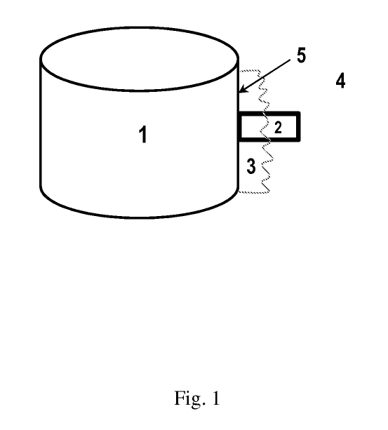

The disclosure is explained by the drawings, where FIG. 1 shows a borehole 1, a region 2 of taking (drilling-out) a core sample from a formation, a damage zone 3 in the vicinity of the borehole, an undamaged formation 4 and a wall 5 of the borehole (a “wellbore-formation” interface).

In accordance with the method, a core sample is taken from the borehole wall (side sampling), see the region 2 in FIG. 1, for example, using a corer or a side core sampler (embodiments of similar core samplers are described in U.S. Pat. No. 4,950,844 of Aug. 21, 1990, or U.S. Pat. No. 5,487,433 of Jan. 30, 1996).

Generally, the core sample (see the sampling region 2 in FIG. 1) can include both a portion affected by a drilling mud (i.e., positioned in the damage zone 3 in FIG. 1) and a portion not affected by the drilling mud (i.e., positioned in the undamaged formation 4 in FIG. 1). Depending upon a depth of the damage zone, a relationship between said core sample portions can vary considerably to the point of disappearance of the damage zone.

At least one core fragment of the core sample is cut. The core fragments are exposed to acoustic (elastic) longitudinal waves and a velocity of an acoustic longitudinal wave in the core fragments (“under study”) is measured, for example, according to the All-Union State Standard (GOST) 21153.7-75 “Porody gornye. Metod opredelenia skorostei rasprostranenia uprugikh prodol'nykh i poperechnykh voln” (Mountain rocks. Method for determining propagation speeds of elastic longitudinal and transversal waves). USSR 1975, items 2 to 4.

An empirical relationship between a longitudinal wave velocity and a porosity for a given lithotype of the rock is selected, for example, an analytical dependence or a dependence in the form of a nomographic chart or a dependence according to the Frenkel-Biot-Nikolaevsky theory. The porosity of the core fragments under study is determined using the selected empirical interrelation and the measured velocities of the acoustic (elastic) longitudinal wave.

The measured porosity values φᵢ and the values φ_{ref} of the reference i.e. undamaged porosity representative of the given lithological type of the rock, are compared and a value of a porosity change (“damage”) induced by the drilling mud is determined according to the relationship φᵢ*=φᵢ/φ_{ref}.

To determine a porosity change (“damage”) depth induced by the drilling mud, two or more core fragments are cut from the core sample, said fragments corresponding to different distances from the borehole wall (the “borehole-formation” interface) 5. Each core fragment (“under study”) is exposed to acoustic longitudinal waves and velocities of the acoustic longitudinal waves are measured. Porosity values φᵢ in each core fragment under study are determined and said values are compared with a value φ_{ref} of the reference porosity representative of the given lithological type of the rock. A value of a porosity change (“damage”) induced by the drilling mud is determined according to the relationship φᵢ*=φᵢ/φ_{ref}. The porosity change (“damage”) depth is determined as a distance from the borehole wall (the “borehole-formation” interface) 5 at which φᵢ reaches the value φ_{ref}, i.e. φᵢ*=φᵢ/φ_{ref} becomes close to unit (φᵢ*≈1).

An undamaged porosity of the similar lithotype of the rock, if it is known from studies performed earlier, or a porosity known from available geological and geophysical information for a given reservoir formation, or a porosity calculated from a velocity of acoustic (elastic) longitudinal waves in a core fragment remote from a wall of the borehole (a “borehole-formation” interface) can be used as the reference porosity. A porosity measured for a core fragment, for example, according to the standard methodology of GOST 26450.1-85 “Porody gornye. Metody opredelenia kollectrorskikh svoistv. Metod opredelenia koeffitsienta otkrytoi poristosti zhidkostenasyshcheniem” (Mountain rocks. Methods for determining reservoir properties. Method for determining the open porosity ratio by saturation with fluid), USSR 1985, can be taken as the reference porosity.

The obtained values of the changed porosity are used to correct an interpretation of acoustic logging data.

To determine a permeability change, there a longitudinal wave attenuation factor or amplitude is measured. An empirical relationship between a wave attenuation factor and a porosity for a given lithological type of the rock is selected, and a value of the permeability change, in other words, the permeability damage, is determined by comparing the obtained permeability values k and a value of a reference, i.e., undamaged permeability k_{ref} representative for the given lithological type using the selected empirical relationship between the wave attenuation factor and the permeability for the given lithological type of the rock. A value of the permeability damage is determined as kᵢ*=kᵢ/k_{ref}. When studying two or more core fragments cut in such a way that they correspond to different distances from the borehole wall (the “borehole-formation” interface) 5, a depth of the permeability change is determined as a distance from the borehole wall (the “borehole-formation” interface) 5 at which k reaches the value k_{ref}, i.e. kᵢ* becomes close to unit (kᵢ*≈1).

A known undamaged permeability of the similar lithotype of the rock, or a permeability calculated on the basis of an attenuation factor of acoustic longitudinal waves measured in a core fragment remote from the wall of the borehole (a “borehole-formation” interface) can be taken as the reference permeability. A permeability measured for a core fragment, for example, according to the standard methodology of GOST 26450.1-85 “Porody gornye. Metod opredelenia koeffitsienta absolutnoi pronitsaemosti pri statsionarnoi ili nestatsionarnoi filtratsii” (Mountain rocks. Method for determining the absolute permeability coefficient in stationary or non-stationary filtration), USSR 1985, can be taken as the reference permeability.

An analytic dependence or a dependence in the form of a nomographic chart or a dependence according to the Frenkel-Biot-Nikolaevsky theory is used as the empirical relationship between the wave attenuation factor and the permeability.

1. A method for determining a change of properties in a near-borehole zone of a formation due to invasion of a drilling mud, the method comprising:
obtaining a core sample from a wall of a borehole;
cutting at least one core fragment from the core sample;
irradiating the at least one core fragment with longitudinal acoustic waves and measuring a propagation velocity of the longitudinal acoustic waves in each of the at least one core fragment;
selecting an empirical relationship between a velocity of a longitudinal acoustic wave and a porosity for a given lithological type of the rock;
determining a porosity for each of the at least one core fragment of the core sample using the measured velocities of the longitudinal acoustic wave and the selected empirical relationship between the velocity of the longitudinal acoustic wave and the porosity for the given lithological type of the rock; and
determining a value for porosity change by comparing the determined porosity values for the at least one core fragment and a value of a reference porosity for the given lithological type of the rock.

2. The method of claim 1, wherein the reference porosity is a known undamaged porosity for a similar lithological type.

3. The method of claim 1, wherein the reference porosity is a porosity known from available geological and geophysical information for the given reservoir formation.

4. The method of to claim 1, wherein the reference porosity is a porosity calculated from a propagation velocity of acoustic longitudinal waves measured in a core fragment, from the core sample, that is remote from the borehole wall.

5. The method of claim 1, wherein the reference porosity is a porosity measured in a core fragment from the core sample.

6. The method of claim 1, wherein an analytical dependence is used as the empirical relationship between (i) the velocity of the longitudinal acoustic wave and (ii) the porosity.

7. The method of claim 1, wherein a dependence in the form of a nomographic chart is used as the empirical relationship between (i) the velocity of the longitudinal acoustic wave and (ii) the porosity.

8. The method of claim 1, wherein a dependence according to the Frenkel-Biot-Nikolaevsky theory is used as the empirical relationship between (i) the velocity of the longitudinal acoustic wave and (ii) the porosity.

9. The method of claim 1, wherein the obtained values of the changed porosity are used to correct an interpretation of acoustic logging data.

10. The method of claim 1, wherein, during the irradiation of each of the at least one core fragment with the longitudinal acoustic waves, a longitudinal wave attenuation factor or amplitude is measured, an empirical relationship between a wave attenuation factor or amplitude and a permeability for a given lithological type of the rock is selected, a value of a permeability change is determined by comparing the obtained permeability values and a value of a reference permeability representative for the given lithological type using the measured longitudinal wave attenuation factors or amplitudes and the selected empirical relationship between the wave attenuation factor or amplitude and the permeability for the given lithological type.

11. The method of claim 10, wherein the reference permeability is a known undamaged permeability for a similar lithological type.

12. The method of claim 10, wherein the reference permeability is a permeability calculated from an attenuation factor of the acoustic longitudinal waves measured in a core fragment, from the core sample, that is remote from the borehole wall.

13. The method of claim 10, wherein the reference permeability is a permeability known from available geological and geophysical information for the given reservoir formation.

14. The method of claim 10, wherein the reference permeability is a permeability calculated from an attenuation factor of the acoustic longitudinal waves measured in a core fragment, from the core sample, that is remote from the borehole wall.

15. The method of claim 10, wherein an analytical dependence is used as the empirical relationship between the wave attenuation factor or amplitude and the permeability.

16. The method of claim 10, wherein a dependence in the form of a nomographic chart is used as the empirical relationship between (i) the wave attenuation factor or amplitude and (ii) the permeability.

17. The method of claim 10, wherein a dependence according to the Frenkel-Biot-Nikolaevsky theory is used as the empirical relationship between (i) the wave attenuation factor or amplitude and (ii) the permeability.

18. The method of claim 1, wherein core fragments corresponding to different distances from the wall of the borehole are cut from the core sample and a depth of the porosity change is determined.

19. The method of claim 18, wherein, during the irradiation of each of the core fragments with the longitudinal acoustic waves, a longitudinal wave attenuation factor or amplitude is measured, an empirical relationship between a wave attenuation factor or amplitude and a permeability for a given lithological type of the rock is selected, a value and a depth of the permeability change is determined by comparing the obtained permeability values and a value of a reference permeability representative for the given lithological type using the measured longitudinal wave attenuation factors or amplitudes and the selected empirical relationship between the wave attenuation factor or amplitude and the permeability for the given lithological type.

20. The method of claim 19, wherein the reference permeability is a known undamaged permeability for a similar lithological type.

21. The method of claim 19, wherein the reference permeability is a permeability known from available geological and geophysical information for the given reservoir formation.

22. The method of claim 19, wherein the reference permeability is a permeability calculated from the attenuation factor of the acoustic longitudinal waves measured in a core fragment, from the core sample, that is remote from the borehole wall.

23. The method of claim 19, wherein the reference permeability is a permeability measured for a core fragment, from the core sample, that is remote from the borehole wall.

24. The method of claim 19, wherein an analytical dependence is used as the empirical relationship between the wave attenuation factor or amplitude and the permeability.

25. The method of claim 19, wherein a dependence in the form of a nomographic chart is used as the empirical relationship between (i) the wave attenuation factor or amplitude and (ii) the permeability.

26. The method of claim 19, wherein a dependence according to the Frenkel-Biot-Nikolaevsky theory is used as the empirical relationship between (i) the wave attenuation factor or amplitude and (ii) the permeability.
